(19) United States
(12) Patent Application Publication
(10) Pub. No.: US 2012/0155669 A1
(43) Pub. Date: Jun. 21, 2012

(54) OPEN-WORKED ACOUSTIC BARRIER FOR HYBRID ACTIVE/PASSIVE NOISE TREATMENT

(75) Inventor: Christian Carme, Marseille (FR)

(73) Assignee: TECHNOFIRST, Aubagne Cedex (FR)

(21) Appl. No.: 13/391,476

(22) PCT Filed: Aug. 20, 2010
(86) PCT No.: PCT/FR2010/051750

§ 371 Date: Feb. 21, 2012

(30) Foreign Application Priority Data
Aug. 21, 2009 (FR) 09 55741

(51) Int. Cl. G10K 11/16

(52) U.S. Cl. 381/71.12

(57) ABSTRACT

The invention relates to a method and a device for passive and active acoustic reduction, including m electro-acoustic bars (41) side by side and separated by gaps (D), thus constituting an open-work acoustic barrier combining passive and active noise-reduction. Each electro-acoustic bar (41) includes a plurality of acoustic reduction elements (70) arranged, side by side, each acoustic reduction element (70) including a microphone (62) and a loudspeaker (61) disposed inside a box (60) made of a passive acoustically absorbent material or including a passive acoustically absorbent material, the microphone (62) and the loudspeaker (61) being connected to control electronics (73) capable of receiving a measurement of the transfer function between the microphone (62) and the loudspeaker (61) and of computing a feedback control electronic filter for each acoustic reduction element (70) from the transfer function between the microphone (62) and the loudspeaker (61), and acting, within each acoustic reduction element (70), to enable the loudspeaker (61) to be electro-acoustically looped to the microphone (62) by amplifying the feedback in order to obtain real-time acoustic absorption for a predetermined, range of frequencies.

### BACKGROUND OF THE INVENTION

The general field of the present invention is acoustic reduction devices and methods.

There exist at present two large families of acoustic reduction devices: the family of passive acoustic reduction devices and the family of active acoustic reduction devices.

The first family includes acoustic barriers or acoustic screens based on inert materials. For example, concrete anti-noise screens or walls have some efficacy for combating road noise. Passive acoustic reduction devices also include glazing units for windows that function as an anti-noise wall when the window is closed.

The drawbacks of passive acoustic reduction devices are that they are opaque visually and generally also thermally. Anti-noise walls do not generally permit heat exchange or limit it very strongly, and they are visually opaque. Furthermore, it is known that acoustic screens generally create re-emission of sound by diffraction at the top of the screen.

As for windows, they cease to treat sound as soon as they are opened.

Passive noise control by screening consists overall in disposing a wall, a door, or a glazing unit between the source of the noise and the place where a reduced noise level is required.

The second family involves active control of noise. An example of active control is described in patent WO 1997/02471. In that document, active noise control is used to reduce noise from ventilation ducts.

The technology described in the above document consists in producing an active acoustic box including a microphone/loudspeaker pair adapted to measure the primary noise emitted in the ventilation duct and to adjust emission from the loudspeaker as a function of that primary noise so as to provide active reduction of that primary noise as emitted in the ventilation duct.

FIG. 1 shows the efficacious area ZEP generally observed with a passive noise reduction system. It is seen that the efficacy of passive noise control is essentially concentrated in the audible frequency spectrum but is of great efficacy only for treating high frequencies.

FIG. 1 also shows the spectrum SR of road noise and if can be seen that this type of noise is characterized by a high concentration of sound at low frequencies. Thus the anti-noise walls generally used are relatively or totally ineffective at the predominant frequencies of the road noise spectrum SR.

Despite the improvement in screen type noise reduction devices over the last three decades, at present this technology is beginning to show its limitations and it is difficult to envisage further improvement over traditional installations.

On this topic, FIG. 2 shows the improvement of the area of efficacy ZEP′ of a passive screen when its thickness is doubled relative to the area of efficacy ZEP shown in FIG. 1 obtained for a wall 10 cm thick. Note that the reduction is increased for high frequencies but remains practically unchanged for low frequencies.

It is moreover known that the efficacy of anti-noise walls on roads is a function of wall height. The greater the height, the greater the reduction of the road noise nuisance.

However, whatever the height of the wail, there is known to exist a phenomenon of sound re-emission from the edge of the anti-noise wall. This well-known phenomenon is linked to diffraction of road noise at the edge of the wall, which edge behaves like a sound source re-emitting the noise.

FIG. 3 is a diagram showing this process of re-emission of a plane wave impinging on the left-hand side of a wall 10. This plane wave is attenuated by the presence of the wall 10, but it is also re-emitted in the form of a spherical wave by the edge of the wall by virtue of the diffraction phenomenon.

This phenomenon greatly degrades the efficacy of the wall by creating sound attenuation areas that are not uniform. To shift this problem of diffraction as far as possible from the wall, it is possible to make a wall as high as possible. This is not really a solution in that this greatly increases the costs associated with the construction of the wall and also in that it greatly increases the windage of the wall.

The efficacy of the active acoustic box technology is subject to two conditions. The first condition is linked to wavelength and the second condition to the speed of electronic processors. It is found that the efficacy of active control is in fact limited at high frequencies by technical/economic reasons.

Thus active systems are found to be more effective for low frequencies than for high frequencies. Moreover, it is at present not possible to achieve active control of high frequencies, which reduces the field of application of this noise control method.

### OBJECT AND SUMMARY OF THE INVENTION

Thus the main object of the present invention is to alleviate the drawbacks of the known prior art devices by proposing a passive and active acoustic reduction method comprising the following steps:

producing a plurality of acoustic reduction elements, each comprising a microphone and a loudspeaker, by carrying out the following steps for each element:
placing the microphone in a box produced in a passive acoustically absorbent material or including a passive acoustically absorbent material in the vicinity of the surface of a main side of the box; and
placing the loudspeaker in this box, beside the microphone, also in the vicinity of the surface of the main side and in such a manner that the main emission direction of the loudspeaker is substantially perpendicular to the main side;

disposing n acoustic reduction elements side by side to constitute an acoustic reduction bar or electro-acoustic bar;

disposing m electro-acoustic bars side by side, substantially parallel to one another, and separated by gaps and directing the main side of the box towards the side opposite the main side of the adjacent bar, so that the loudspeakers fire into the gap between two bars, thus constituting an open-work acoustic barrier combining a passive noise-reduction effect and an active noise-reduction effect;

introducing the acoustically absorbent material on the side of the box opposite the main side to adjust the acoustic impedance of the box and prevent the appearance of a standing wave between the main side of one bar and the side opposite the main side of the adjacent bar;

for each acoustic reduction element, measuring the transfer function between the microphone and the loudspeaker; and

for each acoustic reduction element, computing a feedback control electronic filter from the transfer function between the microphone and the loudspeaker, the transfer function being linearized by the presence of adsorbent material introduced onto the side of the box opposite the main side, the electronic filter acting, within each acoustic reduction element, to enable electro-acoustic looping of the loudspeaker to the microphone by amplifying the feedback in order to obtain a real-time acoustic absorption effect for a predetermined range of frequencies.

Thus the invention enables production of open-work acoustic barriers harmoniously combining noise treatment by means of a passive system and by means of an active system.

Since the active system is carried by structures produced from judiciously disposed passive acoustically absorbent materials, a harmonious combination of active and passive systems is obtained. The active systems are moreover judiciously placed relative to the structures constituting the passive system in such a manner as to optimize their operation by firing into the gap between the passive structures.

Since passive acoustic reduction enables noise at high frequencies to be reduced and since the active device enables sound at low frequencies to be reduced, the invention achieves sound treatment over a wide band.

Moreover, very important advantages are obtained such as reducing the weight of the structures, making natural ventilation possible through the acoustic reduction device, and reducing wind resistance of the acoustic barrier.

The invention also addresses the problem of a window opened to ventilate a dwelling. The invention enables an open-work screen to be created that may be inserted in place of the glazing unit to allow air to pass through while blocking low-frequency noise in the air passages.

In particular, the invention enables road noise to be treated very effectively, which noise is generally treated more effectively by active control than by a conventional passive system.

The introduction of acoustically absorbent material facing each element makes it possible to ensure there are no standing waves between the bars, which could otherwise be harmful because a standing wave is characterized by noise minima and maxima linked to interference between two waves propagating in opposite directions. This is a nuisance because active control works by treating a wave propagating in one direction by using another wave with the opposite phase, not a wave propagating in the opposite direction. With active control, there are therefore only minima and no maxima unless there is reverberation of the wave at a point. Under such circumstances, in the presence of active control, the acoustically absorbent material prevents the wave from being reflected and causing interference in the opposite direction. The advantages of combining active noise control elements and passive sound reduction elements in synergistic relationship with active control are explained below.

The presence of acoustic material facing the active control elements improves the transfer function of the space between the active control elements and the structures supporting those elements that is indispensable in an open-work barrier. This enables the modulus and phase of the transfer function to be smoothed and optimized by linearization. Control of the filter by the microphone then enables the loudspeaker to be looped via the microphone. This increases the overall bandwidth and the amplitude of active noise control. The active/passive combination makes the open-work barrier highly effective when produced in this way in accordance with the principles of the invention.

The combined use of the two noise-reduction principles enables road noise to be treated in highly efficacious manner.

The use of a plurality of aligned acoustic reduction elements and a plurality of bars, each comprising an alignment of acoustic reduction elements, implies the presence of noise control by virtue of the independent operation of each device in isolation. The alignment on the same side of the bar enables the primary wave to be treated uniformly. Moreover, the parallel bars enable sound attenuation to be uniform over the barrier. If the bars are not substantially parallel, then greater or lesser attenuation is observed depending on the distance between the bars, and that is deleterious. Here the expression “substantially parallel” means that the bars may be strictly parallel, which is the most favorable situation, but also that the bars may be at a slight angle to each other resulting in gaps between them being of slightly trapezoidal shape.

With the invention, the computation of the feedback control electronic filter may enable electronic*filtering to be provided for controlling this anti-noise.

Thus the secondary noise coming from each box is treated at the same time as the primary noise that the acoustic reduction device is adapted to reduce. This prevents one box interfering with another.

The hybrid active/passive acoustic reduction device of the invention thus enables sound barriers to be produced that are acoustically opaque at low and medium frequencies but optically translucent and/or open to allow the passage of light and/or hot or cold flows of air and to allow heat exchange.

Applications, of the invention therefore relate to windows likely to be opened, to road noise barriers, and to all types of sound screen such as are sometimes installed on the roofs of buildings that have air-conditioning heat exchangers or other types of noisy machinery disturbing the neighborhood.

According to an advantageous feature of the invention, the electronic filter is further such that emissions from the loudspeakers aligned on the bar interfere positively and additively.

This positive and additional interference contributes an additional effect to operation of the filter by feedback alone.

In one implementation of the invention, the box is common to a plurality of acoustic reduction elements of the same bar.

The use of a common box for a plurality of acoustic reduction elements makes it easier to produce the bars of the invention.

According to an advantageous feature of the invention, the method includes a step of optimizing the distance between two bars as a function of the acoustic result in terms of the number of decibels and the cut-off frequencies of the active reduction, of its visual appearance, and of heat exchange.

According to a preferred feature of the invention, for an acoustic barrier having a free edge, the method further includes a step of installing acoustic reduction elements on that free edge to reduce sound diffraction.

The invention enables sound diffraction at the edges of acoustic screens to be treated by means of an active system alone.

Passive systems can do nothing to combat sound diffraction. In contrast, computing a specific filter that makes use of the transfer function between each microphone and each loudspeaker of the acoustic reduction elements present on the acoustic bar placed at the top of a passive screen enables the diffracted noise to be controlled actively. This enables sound re-emission on the other side of the acoustic barrier of the invention to be reduced significantly.

In one particular implementation of the invention, the bar constituted of a plurality of acoustic elements is replaced by a linear loudspeaker associated with at least one microphone disposed in the vicinity of the loudspeaker.

This feature uses a simplified form of loudspeaker that may be miniaturized rather than a plurality of loudspeakers and microphones in alignment.

The predetermined frequency range is advantageously the range of low frequencies below 500 hertz (Hz).

This frequency range corresponds to the spectrum accessible to active acoustic reduction systems that it is technically possible to implement at moderate cost. The open-work screen therefore enables low frequencies to be treated. Beyond this frequency, the natural barrier of the bars performs like a normal screen for high frequencies.

The invention also provides a passive and active acoustic reduction device comprising m electro-acoustic bars disposed side by side, and separated by gaps, each electro-acoustic bar including a plurality of acoustic reduction elements disposed side by side, each acoustic reduction element comprising a microphone and a loudspeaker placed in a box produced in a passive acoustically absorbent material or including a passive acoustically absorbent material, in the vicinity of the surface of a main side of the box in such a manner that the main emission direction of the loudspeaker is substantially perpendicular to the main side, the microphone and the loudspeaker being connected to control electronics adapted to receive a measurement of the transfer function between the microphone and the loudspeaker;

each bar including an acoustically absorbent material on the side of the box opposite the main side for adjusting the acoustic impedance of the box and preventing the appearance of standing waves between the main side of one bar and the side opposite the main side of the adjacent bar;

the bars being disposed substantially parallel to one another side by side in such a manner that the main sides of the acoustic elements are directed towards the side opposite the main side of the adjacent bar so that the loudspeakers fire into the gap between two bars, thus constituting an open-work acoustic barrier combining a passive noise-reduction effect and an active noise-reduction effect;

the control electronics including means for computing a feedback control electronic filter for each acoustic reduction element from the transfer function between the microphone and the loudspeaker, the transfer function being linearized by the presence of absorbent material introduced onto the side of the box opposite the main side, the electronic filter acting, within each acoustic reduction element, to enable electro-acoustic looping of the loudspeaker to the microphone by amplifying the feedback in order to obtain a real-time acoustic absorption effect for a predetermined range of frequencies.

In a preferred implementation, the last two steps of the method of the invention of measuring the transfer functions and of computing a filter are determined by computer program instructions.

Consequently, the invention also provides a computer program on a data medium, the program being adapted to be executed in a computer, the program including instructions adapted to execute the last two steps of the method of the invention.

The program may use any programming language and may take the form of source code, object code, or code intermediate between source code and object code, such as a partially-compiled form, or any other desirable form.

The invention also provides a computer-readable data medium containing instructions of a computer program as referred to above.

The data medium may be any entity or device capable of storing the program. For example, the medium may include storage means, such as a read only memory (ROM), for example a compact disk (CD) ROM or a micro-electronic circuit ROM, or magnetic storage, means, for example a floppy disk, a hard disk, a flash memory, a universal serial bus (USB) stick, etc.

Also, the information medium may be a transmissible medium such as an electrical or optical signal, which may be routed via an electrical or optical cable, by radio or by other means. The program of the invention may in particular be downloaded over an Internet-type network.

Alternatively, the information medium may be an integrated circuit in which the program is incorporated, the circuit being adapted to execute the method in question or to be used in its execution.

### BRIEF DESCRIPTION OF THE DRAWINGS

Other features and advantages of the present invention emerge from the following description given with reference to the appended drawings, which show a non-limiting embodiment of the invention. In the figures:

FIG. 1 shows the area of efficacy of a passive attenuation system and the frequency spectrum of road noise;

FIG. 2 shows the sound reduction of a passive screen of double thickness;

FIG. 3 is a diagram showing an example of sound re-emission by the edge of a wall;

FIG. 4 shows an acoustic barrier structure of the invention;

FIG. 5 shows the passive/active combination of the invention for treatment of road noise;

FIG. 6 is a diagram showing an acoustic bar of the invention;

FIG. 7 is a diagram of an acoustic reduction element used in a bar of the invention;

FIGS. 8a and 8b show examples of acoustic barriers of a preferred embodiment of the invention;

FIG. 9 shows an example of a window fitted with an acoustic reduction device of the invention;

FIG. 10 is a graphic expression of the transfer function Hex(ω) in the complex plane;

FIGS. 11a and 11b are graphic expressions of the modulus and the phase of an electro-acoustic system subject to interference by standing waves; and

FIGS. 12a and 12b show transfer functions Hex(ω) non-optimized and optimized by the presence in accordance with the invention of a passive material placed in front of the loudspeaker.

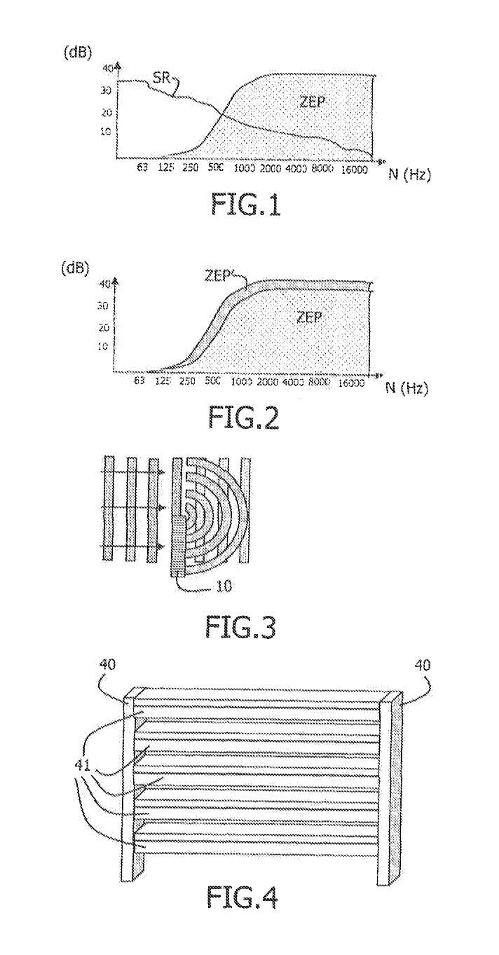

### DETAILED DESCRIPTION OF ONE EMBODIMENT

FIG. 4 shows an example of an acoustic barrier structure of the invention. Between two fixing posts 40 there is disposed a plurality of acoustic bars 41, here 5 bars (m=5). These bars 41 are linear structures separated by a distance D enabling air and light to pass through.

The acoustic bars 41 constitute passive noise reduction elements. They are therefore advantageously produced from passive acoustically absorbent materials or they include acoustically absorbent materials to enable partial acoustic isolation at high frequencies.

According to the invention, each acoustic bar 41 includes a plurality of identical and independent active systems associated physically and mechanically to produce an active acoustic effect in the gaps of thickness D between the passive acoustic bars. The plurality of acoustic bars 41 enables a combination of active and passive treatment to be obtained.

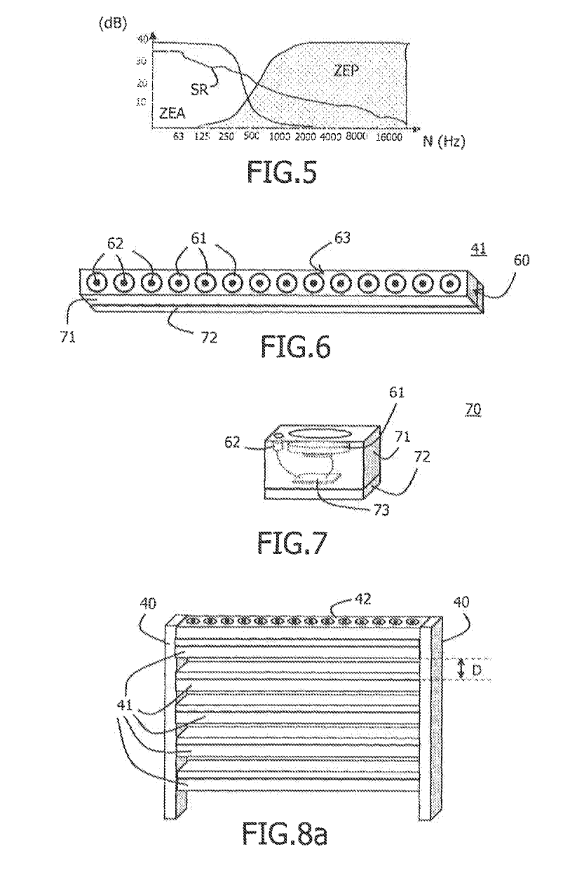

The invention thus enables treatment to be performed over a wide band, as shown in FIG. 5. This FIG. shows the area of passive efficacy ZEP and the area of active efficacy ZEA together with the spectrum SR of road noise. Note that, even if the open-work nature of the anti-noise device inevitably leads to a decrease in the efficacy of passive acoustic reduction, the acoustic reduction generated by the active means enables such a decrease to be more than compensated since the highest intensities of road noise SR are found in the low frequencies that active treatment handles.

FIG. 6 shows an acoustic bar 41. According to the invention, this bar is advantageously constituted of a box 60 on which there are placed loudspeakers 61 and microphones 62. Each microphone/loudspeaker pair

constitutes an acoustic reduction element in the sense of the invention. In the FIG. 6 example, the bar 41 comprises 14 microphone/loudspeaker pairs (i.e. n=14) placed on a side of the box 60 called the main side 63.

Note that the main side is not visible on the bars 41 in FIG. 4 since, being oriented downwards, the perspective adopted prevents them from being seen.

FIG. 7 shows one such acoustic reduction element 70 comprising a metal enclosure 71 on the back of which is placed a passive absorbent material 72 such as mineral wool, for example. This absorbent material is used to adjust the acoustic impedance into which the loudspeakers on the main side 63 of the adjacent bar fire. The enclosure 71 is for example a metal acoustic enclosure serving as a box in the sense of the invention.

Within the enclosure 71 there are placed the loudspeaker 61 and the microphone 62. The microphone 62 provides a reference for computing what the loudspeaker 61 constituting a secondary source is to emit.

The presence of the passive absorbent material 72 on the back of the metal enclosure 71 makes it possible to adjust the acoustic impedance into which there fire the secondary sources consisting of the loudspeakers placed on the adjacent bar facing the back of the bar in question. In the FIG. 4 acoustic barrier, the passive absorbent material 72 serves to adjust the impedance of the loudspeakers situated on the bar above the bar in question because the loudspeakers fire downwards. It should be observed that the loudspeakers could fire upwards or downwards or to the left or to the right of the acoustic barrier, as a function of the structure chosen for the barrier.

The passive absorbent material 72 must also be fairly absorbent in order to prevent standing waves arising between the top of one bar and the bottom of the adjacent bar, which is for example that which fires into the gap of thickness D between the two bars.

The principles of the acoustic adjustment are explained below. When a feedback-type active control system is constructed, it is necessary to characterize the acoustic medium to determine its frequency characteristics and the sound level at each frequency.

A valuable tool, as claimed, measuring the transfer function between the transducers (microphone and loudspeaker) that are to create the required acoustic effect. That effect is active reduction of noise in accordance with the invention.

The first criterion to be verified in active noise control is the stability of the system in operation. Filtering and amplifying the sound signal emitted by the loudspeaker to obtain active noise control naturally creates positive sound amplification and not sound reduction, which may be deleterious in the event of instability.

This phenomenon, “howlaround” or the Larsen effect, is well-known to sound engineers responsible for the sound system in an auditorium. Sound engineers move the microphones away from the loudspeakers to eliminate the Larsen effect. There also exists a scientific way to address this problem, entailing analysis by means of a physical criterion called the Nyquist criterion.

The Nyquist criterion is a measurement in the complex plane of the expression of the transfer function Hex(ω) of the complete electro-acoustic system: loudspeaker, acoustic medium (impedance of the walls, distance, microphone, amplifier, and correction filter).

If the looped system is unstable, this amounts to stating that the characteristic equation expressed in modulus and in phase verifies the following equation for a zero phase:

(|1−K.C(ωi).Hex(ωi)|, 0)≦(0, 0) where K is the gain, C the correction filter, and Hex(ω) the complex expression for the electro-acoustic open loop.

In this situation, for points with an affix with a zero imaginary part (|K.C (ωi).Hex(ωi)|, 0), the open loop Nyquist locus verifies the following condition:

(|K.C(ωi).Hex(ωi)|, 0)≧(1, 0)

The Nyquist graphic stability criterion may be stated as follows: “For a regular and stable open-loop linear system, the system looped by feedback is stable if the Nyquist locus does not surround the complex point (1, 0) or leaves it on the right in the sense of increasing ωi″.

The open loop Nyquist locus is computed for each frequency. The points of intersection of this Nyquist locus with the real axis are computed. The stability constraint Rmax is then defined on the basis of the highest abscissa of points of intersection of the open loop Nyquist locus with the real axis. An example of the graphic determination of the stability constraint Rmax is shown in FIG. 10.

It is seen in this figure that the real axis is intersected several times by the open loop Nyquist locus. The constraint Rmax is a complex point (0.9, 0) that is less than the critical point. The open loop locus of the system does not surround the point (1, 0) in the direction of increasing co. The closed loop electro-acoustic system is therefore stable for the modulus and phase values in question.

To summarize this criterion, amplification of the sound must be avoided if the phase of the complex expression of the sound goes to 0°. If the Larsen effect occurs, there is a large amount of phase rotation and a phase passes through 0° at a frequency of energy that is greater than 0 dB. When sound engineers move the microphone away from the loudspeaker, the transfer function changes, and thus the amplitude and the phase of the signal change.

Although it is possible to solve this problem of sound treatment; stability by such empirical means, for an active noise control system using feedback implemented as in the invention, preventing the Larsen effect requires working both with the modulus and with the phase of the signal provided by the transfer function of the open loop electro-acoustic system.

It is therefore necessary to achieve sound reduction in a given frequency band. This amounts to conforming to the Nyquist criterion even when sound within a given frequency :band is amplified.

The problem of active noise control by feedback is therefore stated in terms of the following criteria:

a chosen frequency band;

the greatest possible amplification of the sound in the chosen frequency band to obtain the greatest possible noise reduction;

a system that is stable (in the Nyquist sense) when the system is operating.

In this situation, the possibility of modifying the transfer function is limited to modifying only the phase, since the frequency band has been chosen and sound amplification is imposed by the very idea of active noise control.

In the earlier patent FR 2 595 498 describing a headset with active noise control, the solution chosen is to implement a special “trefoil” filter that enables amplification of sound within a given bandwidth without degrading the phase and with limited phase rotation in the treatment frequency band, thus yielding a system that is stable according to the Nyquist criterion.

The filtering power provided by that “trefoil” filter is used for a headset and could also be used in an active box of the type used by the invention. However, the “trefoil” filter does not solve all the problems encountered when the boxes are positioned on a bar.

The limitations of the active acoustic system using such a filter are linked to the complex electro-acoustic structure of the system. This complexity is reflected in the frequency response Hex(ω) by a non-constant modulus, formed of resonances and anti-resonances, and a phase including singular phase rotations or advances.

The construction of open-work screens in which rows of boxes are disposed with the active faces of their loudspeakers firing onto the back of the next row of boxes with a small distance (typically less than or equal to 20 centimeters (cm)) between rows of boxes creates standing wave phenomena in this confined space.

These standing waves enormously degrade the nature and quality of the transfer function for use in active control. They cause large phase rotations and significant anti-resonances in the modulus of the signal. These phenomena are generally referred to as sound nodes. This renders any looped system unstable in the Nyquist sense and limits the bandwidth associated with the active acoustic treatment.

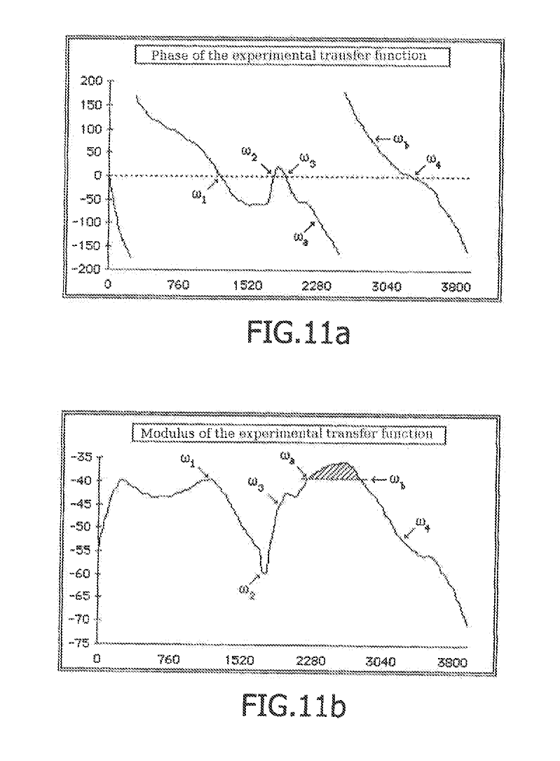

FIGS. 11a and 11b show curves representing an example of measurement of a transfer function polluted by these standing waves.

Even when using the “trefoil” filter, this kind of transfer function limits active treatment to the frequency band [ωₐ,ω_{b}] because of the presence of numerous phase rotations associated with phase cancellations that generate resonances, notably at ω₁, and anti-resonances, notably at ω₂.

The Kundt tube, provided with a perfectly reflecting termination, is an approximate example of this type of phenomenon with standing waves for which the phase is a zero phase and the modulus corresponds to a cosine function when the position of the measurement point moves in the tube. A progressive acoustic wave appears in this tube only when the. termination is of anechoic type.

An optimized transfer function Hex(ω) having a modulus that is as constant as possible and a phase that has the lowest possible rotation may be envisaged if attention is directed to the acoustic impedance of this anechoic termination in the Kundt tube.

When an acoustic wave is produced in a domain Ω partially closed by boundaries Γ, the wave regime is transformed into a standing wave regime. The acoustic energy contained in this space is then determined by the nature of the walls.

Where the presence of the open-work screens is concerned, the dimensions are less than or equal to the wavelengths at which the. active system must operate. This generates the presence of standing waves.

The transfer function Hex(ω) of a box facing an absorbent passive wall corresponds to the open-work system of the invention combining active control and passive control. It may be expressed by the transfer function Hhp(ω) of the loudspeaker modified by the front and rear acoustic load linked to the walls.

The radiation from the loudspeaker then has a rear acoustic impedance, because of the cavity of the box, and a front acoustic impedance, because of the wall of passive material fixed to the rear of the successive box.

The influence of the passive materials on the acoustic emission from the loudspeaker enables the role of the passive material facing the loudspeaker to be determined in the expression of the overall transfer function Hex(ω).

It is possible to model the loudspeaker in anti-noise operation facing a wall of given acoustic impedance. The transfer function Hhp(ω) of the loudspeaker, treated as a plane piston, is defined as the ratio of the speed V(ω) of movement of the diaphragm to the excitation voltage E(ω) delivered to the terminals of the loudspeaker such that:

$$∀ ω , {H}_{hp} ( ω ) = \frac{V ( ω )}{E ( ω )} = \frac{B l}{{Z}_{e} {Z}_{m} + {( B l )}^{2}}$$

in which B.l is the product of the magnetic field B of the air gap and the length l of the winding, Ze is the electrical impedance, and Zm is the mechanical impedance.

In this expression for Hhp(ω), the acoustic impedances of the absorbent materials at the front and at the rear of the loudspeaker that modify its acoustic radiation are introduced. These impedances operate acoustically and mechanically on the vibration of the diaphragm. These acoustic-mechanical impedances may thus be added to the term Zm that represents the mechanical impedance of the loudspeaker. The transfer function of the loaded loudspeaker then becomes:

$${H}_{ch} ( ω ) = \frac{B \times l}{{Z}_{e} \times ( {Z}_{m} + {Z}_{ar} + {Z}_{av} ) + {( B \times l )}^{2}}$$

where Zar and Zav are respectively the. rear and front acoustic impedances created by the presence of the passive material in the box behind the loudspeaker and the passive material facing the loudspeaker and stuck to the rear of the. next box.

To compute these impedances Zar and Zav, it is useful to assume that the acoustic wave emitted by the loudspeaker propagates as a plane wave. The rear impedance Zar then verifies the following equation (in ρc units):

$${Z}_{ar} = \frac{s}{{S}_{cav}} \times \frac{1 - R - j 2 R sin ( 2 k {l}_{cav} )}{1 + R - 2 R cos ( 2 k {l}_{cav} )}$$

where s is the area of the piston, S_{cav} is the section of the box concerned, k=ω/C, and R is the coefficient of reflection of the walls linked to the presence or absence of acoustically absorbent passive material.

The transfer function of the loudspeaker loaded by the front and rear acoustic impedances is then in fact the product of the following three transfer functions:

H_{ch}(ω)=C_{A}(ω)Hₕₚ(ω)C_{B}(ω)

where C_{A}(ω) and C_{B}(ω) are respectively the acoustic transfer functions of the cavity of the box and the space confined between the slats situated in front of the loudspeaker.

If the excitation E(ω) of the loudspeaker is white noise, the expression for Hch(ω) is none other than the transfer function of the electro-acoustic system of the box coupled to the confined space between the box and the passive material on the rear of the next box.

Accordingly, by considering that the frequency response of the measurement microphone is perfect, at least in the frequency band of interest, the transfer function Hch(ω) is equivalent to the experimental transfer function Hex(ω) of the box system firing onto an absorbent passive acoustic wall.

The variations of the three transfer functions that constitute the expression for Hch(ω) thus correspond to the variations of the transfer function Hex(ω).

It is therefore necessary to determine the key parameters operative in modifying and optimizing the modulus and phase responses of the transfer function of the electro-acoustic box when it fires either onto a perfectly reflective wall or onto an acoustically absorbent passive wall.

It is assumed here that the parameters Ze, Bl, Zm remain constant for a given loudspeaker.

The variation Zar as a function of R, which v4aries in the range [0, 1], means that the impedance Zar varies in the range [+∞, −∞]. These values change sign and feature discontinuities at the limits of the defined interval.

Thus if R varies in the range [0, 1], the transfer function Hch(ω) may vary from zero to very high values depending on the variations of Zar and Zav. These variations explain the occurrence of the rapid phase rotations and the resonances and anti-resonances in the modulus that are observed on the Bode diagrams of the experimental transfer functions.

Where the variations of s and Scav are concerned, they are essentially reflected in modifications of the value of the gain for the modulus of Hhp(ω) without truly degrading the phase.

The modulus and phase curves of the transfer function Hex(ω) of the complete electro-acoustic system are then smoothed by adding a passive material to change the front acoustic impedance of the loudspeaker of the invention.

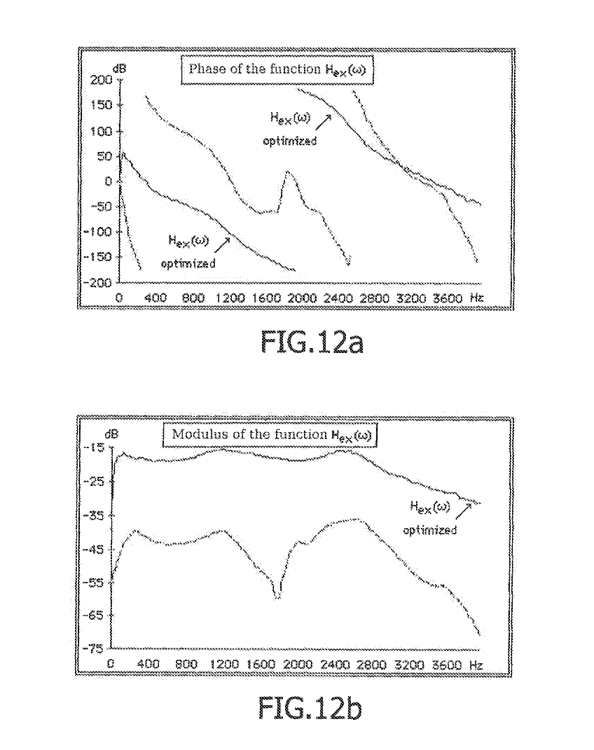

The experimental transfer functions Hex(ω) shown in FIGS. 12a and 12b are derived from measurements effected on an open-work system in which the rear wall of the box facing the loudspeaker is sometimes made of metal and sometimes made of metal covered with a 5 cm thick passive absorbent material.

The non-optimized transfer function corresponds to open-work screens in which the rear of the box carries no passive acoustic absorbent material. The measurement of the optimized transfer function corresponds to open-work screens of the invention equipped with a passive material.

It has thus been verified experimentally that the modulus and phase of the transfer function are smoother. The phase shifting is then reduced and the modulus no longer features anti-resonances.

It may be said that optimizing the experimental transfer function by adding a passive material in the expression for the transfer function Hex(ω) of the open-loop feedback system produces pseudo-linearization of the expressions for the phase and the modulus. Combining active noise reduction elements with passive acoustic absorbent elements enables an effective open-work barrier to be obtained conforming to the principles of the invention.

Thus for each open-work barrier it is necessary to optimize Hex(ω) by means of a combination with passive materials on the faces that face the active noise reduction elements. The active control solution is then improved in terms of bandwidth and efficacy by means of adding a passive material that reduces phase rotations and consequently moves the critical point farther away in the complex plane.

This combination of active/passive control enables the attenuation frequency band to be widened and the gain to be increased with no risk of rapidly creating an unstable closed-loop system when the active noise reduction elements are aligned on a bar and then placed in such a manner as to create an open-work barrier of the invention.

The more the transfer function is linearized by combination with a passive material in the expression Hex(ω) for the electro-acoustic system, the greater the improvement in:
the efficacy of active acoustic attenuation;
the width of the attenuated frequency band;
the reliability of the system, which may be controlled by simpler electronics.

The optimization of the transfer function obtained by combining the active control system and an acoustically absorbent material disposed face to face may be complemented by a judicious choice of transducers the transfer function of which offers little phase rotation and deformation of the modulus.

The microphone 62 and the loudspeaker 61 are connected to control electronics 73. The control electronics 73 comprise a pre-amplifier for the microphone 61, an electronic filter, for example an Nth order filter, and an audio power amplifier connected to the loudspeaker 61.

Combining a plurality of basic boxes as shown in FIG. 7 produces an acoustic treatment bar of the invention. In reality, as shown in FIG. 6, the box is advantageously shared, being of linear shape, by fourteen acoustic reduction elements each composed of a microphone and a loudspeaker.

The computations effected in the control electronics 73 ensure that the control filtering is such that the active sources interfere positively and additively. This ensures that the overall treatment is uniform.

The invention allows overall coherence of the open-work hybrid acoustic barrier of the invention by adjusting the filtering that is effected as a function of the transfer function of each independent box. To be more precise, the transfer function of the secondary path, i.e. of the path between the microphone and the loudspeaker of each microphone/loudspeaker pair, is used to adjust the filtering. The transfer function of the secondary path is like an electro-acoustic identity card enabling everything in the complex plane to be controlled for the frequency band envisaged for the treatment.

Measuring the transfer function between each microphone and the corresponding loudspeaker provides the modulus and phase of this secondary path for all the treatment frequencies concerned. Thus it is possible, by calculation, to master the behavior and the stability of the microphone/loudspeaker pair, taking into account all of the acoustic characteristics of the system for optimum computation of the solution filter enabling maximum gain for assured system stability.

An example of feedback control that may be employed in the invention is given in patent application WO 1997/02471.

Note that the active noise treatment cut-off frequency and the reduction in dB looked for condition the thickness D of the layer of air that exists between two bars 41. Thus the bandwidth treated at low frequencies by active treatment and the reduction in dB obtained in that band are inversely proportional to the thickness of the layer of air between two bars. There follows by way of illustration a table of the resulting reduction in dB as a function of the distance between two bars.

Reduction in dB in octave bands as a function of
distance between two active/passive bars

| Frequency | E = 2 cm | E = 4 cm | E = 8 cm | E = 16 cm | E = 32 cm |
|---|---|---|---|---|---|
| 31.5 | 24 | 24 | 24 | 24 | 24 |
| 63 | 24 | 24 | 24 | 24 | 12 |
| 125 | 24 | 24 | 24 | 12 | 6 |
| 250 | 24 | 24 | 12 | 6 | 3 |
| 500 | 24 | 12 | 6 | 3 | 0 |

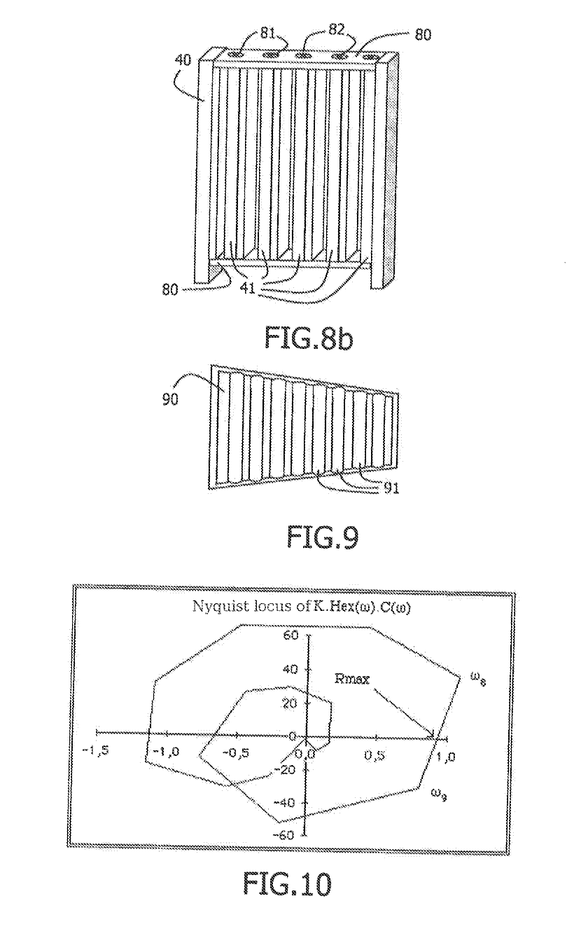

FIGS. 8a and 8b show examples of acoustic barriers produced in accordance with a preferred embodiment of the invention for which the acoustic barrier is provided with acoustic reduction elements on its upper part for treatment of said fraction by the upper edge of the acoustic barrier.

In FIG. 8a, the barrier is provided with an additional acoustic box 42. This additional bar 42 does not encounter any problem with regard to adjustment of the acoustic impedance since the loudspeakers on this bar fire into free space and therefore have infinite acoustic impedance.

In FIG. 8b, active treatment of the diffracted noise is provided by a plurality of acoustic reduction elements constituted of microphone 62 and loudspeaker 61 pairs placed at the ends of the bars 41 placed vertically between two cross-members 80.

Note that a loudspeaker of the type described for a double-glazing installation in patent WO 99/05888 could be used in combination with a microphone to produce a system of the invention. In particular, an elongate secondary source of this kind may be used in an acoustic reduction device intended to be used in the manner of a slatted blind in front of a window.

The invention enables an active noise treatment system to be disposed on the edges of slats of the slatted blind type or on the perimeter of cylinders suspended parallel to the window. After adding acoustically absorbent material to the faces opposite the faces on which the active systems are installed, it is thus possible to arrive at an agreeable and effective arrangement for treating noise at low frequencies at the same time as enabling effective ventilation and cooling of a room.

The use of a cylinder is advantageous from a passive noise reduction point of view. The mass effect of a cylinder compared to a slat is considerably greater. Furthermore, the presence of the cylinder enables adjustment if necessary of the acoustic impedance into which the adjacent loudspeakers fire.

Using a succession of translucent active/passive modules equipped with elongate loudspeakers the size of the window produces a kind of blind comprising slats or preferably cylinders approximately 9 cm apart and advantageously integrating the control electronics into each slat or cylinder. For a standard 148 mm×123 mm window it is possible to insert five elements, each element having a width or a diameter of approximately 16 mm.

Such a noise treatment system is advantageously connected to the electrical mains supply and controlled by an electrical switch like those used to control the lighting in a room.

Thus an acoustic reduction device of the invention may be installed between an exterior shutter and a window. It may be fixed or removable. The elements may be moved over the sides of the window or integrated into a brick on edge partition.

FIG. 9 gives an example of one possible embodiment of an acoustic reduction device in a window 90 with cylinders 91 each provided on one side with a linear structure according to the invention with loudspeaker/microphone pairs.

Note that here the invention enables a noise reduction result that is more comfortable to the ear than merely totally passive or totally active control over the whole of the area of the barrier, despite partial active control effected only in the gaps of the barrier and partial passive, control effected only by the bars of the barrier.

Thus the invention enables the production of acoustic screens offering high performance throughout the audible spectrum without requiring the use of great mass or of thick materials. It also has the advantage that it may be associated with treatment of air inlets by active control and therefore that it may be installed as an acoustic curtain in front of machinery requiring considerable ventilation: air-conditioning or other machinery.

For example, with the hybrid active/passive treatment of the invention, it has been possible to obtain an additional overall reduction of 7 dB compared to a passive screen of the same thickness, in the context of reducing the noise radiated by a heat pump type heat exchange system.

In such an application, it is crucial to permit the flow of air necessary for heat exchange to take place, and the invention is thus particularly suited to this type of application. Since such systems are particularly noisy, the invention finds a very beneficial application here.

Strong elongate loudspeakers are advantageously used in the upper part of the acoustic barrier to treat the diffraction.

On a road noise barrier, the active open-work partitions of the invention make it possible to see through the barrier and to pass ventilation. The separation distances D of the bars used, the number of bars, and their vertical or horizontal disposition may vary as a function of the specifications. The aim is generally to achieve a compromise between the quantity of passive material to be used and the cost of the active systems to favor the openness and lightness of the structure.

Note finally that diverse implementations may be produced that conform to the principles of the invention.

1. A passive and active acoustic reduction method comprising the following steps:
producing a plurality of acoustic reduction elements, each comprising a microphone and a loudspeaker, by carrying out the following steps for each element:
placing the microphone in a box produced in a passive acoustically absorbent material or including a passive acoustically absorbent material in the vicinity of the surface of a main side of the box; and
placing the loudspeaker in this box, beside the microphone, also in the vicinity of the surface of the main side and in such a manner that the main emission direction of the loudspeaker is substantially perpendicular to the main side;
disposing n acoustic reduction elements side by side to constitute an acoustic reduction bar or electro-acoustic bar;
disposing m electro-acoustic bars side by side, substantially parallel to one another and separated by gaps and directing the main side of the box towards the side opposite the main side of the adjacent bar, so that the loudspeakers fire into the gap between two bars, thus constituting an open-work acoustic barrier combining a passive noise-reduction effect and an active noise-reduction effect;
introducing an acoustically absorbent material on the side of the box opposite the main side to adjust the acoustic impedance of the box and prevent the appearance of standing waves between the main side of one bar and the side opposite the main side of the adjacent bar;
for each acoustic reduction element measuring the transfer function between the microphone and the loudspeaker; and
for each acoustic reduction element, computing a feedback control electronic filter from the transfer function between the microphone and the loudspeaker, the transfer function being linearized by the presence of adsorbent material introduced onto the side of the box opposite the main side, the electronic filter acting, within each acoustic reduction element, to enable electro-acoustic looping of the loudspeaker to the microphone by amplifying the feedback in order to obtain a real-time acoustic absorption effect for a predetermined range of frequencies.

2. The method according to claim 1, wherein electronic filter is further such that emissions from the loudspeakers aligned on the bar interfere positively and additively.

3. The method according to claim 1, wherein the box is common to a plurality of acoustic reduction elements of the same bar.

4. The method according to claim 1, further comprising a step of optimizing the gap between two bars as a function of the acoustic result in terms of the number of decibels and the cut-off frequency of the active reduction, of its visual appearance, and of heat exchange.

5. The method according to claim 1, further comprising a step of installing acoustic reduction elements on that free edge to reduce sound diffraction so as to form an acoustic barrier having a free edge.

6. The method according to claim 1, wherein the bar constituted of a plurality of acoustic elements is replaced by a linear loudspeaker associated with at least one microphone disposed in the vicinity of the loudspeaker.

7. The method according to claim 1, wherein the predetermined frequency range treated by the open-work screen is the range of low frequencies below 500 Hz.

8. A passive and active acoustic reduction device comprising m electro-acoustic bars disposed side by side, substantially parallel to one another, and separated by gaps, each electro-acoustic bar including a plurality of acoustic reduction elements disposed side by side, each acoustic reduction element comprising a microphone and a loudspeaker placed in a box produced in a passive acoustically absorbent material or including a passive acoustically absorbent material in the vicinity of the surface of a main side of the box in such a manner that the main emission direction of the loudspeaker is substantially perpendicular to the main side, the microphone and the loudspeaker being connected to control electronics adapted to receive a measurement of the transfer function between the microphone and the loudspeaker;
each bar further including an acoustically absorbent material on the side of the box opposite the main side for adjusting the acoustic impedance of the box and preventing the appearance of standing waves between the main side of one bar and the side opposite the main side of the adjacent bar;
the bars being disposed side by side in such a manner that the main sides of the acoustic elements are directed towards the side opposite the main side of the adjacent bar so that the loudspeakers fire into the gap between two bars, thus constituting an open-work acoustic barrier combining a passive noise-reduction effect and an active noise-reduction effect;
the control electronics including means for computing a feedback control electronic filter for each acoustic reduction element from the transfer function between the microphone and the loudspeaker, the transfer function being linearized by the presence of absorbent material introduced onto the side of the box opposite the main side, the electronic filter acting, within each acoustic reduction element, to enable electro-acoustic looping of the loudspeaker to the microphone by amplifying the feedback in order to obtain a real-time acoustic absorption effect for a predetermined range of frequencies.
